(19) United States
(12) Patent Application Publication
(10) Pub. No.: US 2003/0008766 A1
(43) Pub. Date: Jan. 9, 2003

(54) Process for regenerating a metathesis catalyst

(75) Inventors: Virginie Kruger-Tissot, Malakoff (FR); Severine Guibert, Bougival (FR); Dominique Commereuc, Meudon (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: Institut Francais du Petrole, Rueil Malmaison Cedex (FR)

(21) Appl. No.: 10/138,408

(22) Filed: May 6, 2002

(30) Foreign Application Priority Data
May 7, 2001 (FR) 01/06.148

(51) Int. Cl. B01J 38/52

(52) U.S. Cl. 502/24; 502/29

(57) ABSTRACT

An improved process for regenerating metathesis catalysts that comprise a compound of rhenium, molybdenum or tungsten on a porous substrate that consists of a refractory oxide and that has an acidic, neutral or basic nature, and an organometallic promoter that consists of an alkyl complex of tin or lead is described. The regeneration comprises a selective extraction of the organometallic promoter followed by a calcination and a reimpregnation by the same promoter.

This invention relates to a process for regenerating an olefin metathesis catalyst that contains a compound of rhenium, molybdenum or tungsten on a porous substrate that consists of a refractory oxide that has an acidic, neutral or basic nature and that comprises an organometallic promoter that consists of an alkyl complex of tin or lead.

The metathesis of olefins, or the reaction for shuffling the alkylidene groups, has a significant practical advantage, for example for rebalancing among them the light olefins that are obtained from steam-cracking, such as ethylene, propylene and butenes.

Different types of catalysts are able to be used in the metathesis reaction, either homogeneous, when their constituent elements all are soluble in the medium of the reaction, or heterogeneous, when at least one of the elements is insoluble in said medium. These catalysts are most often based on rhenium, molybdenum or tungsten. The heterogeneous catalysts are particularly advantageous when the active metal is expensive and it is necessary to consider its reuse without losses. This is the case, for example, of rhenium-based catalysts whose use in heterogeneous form was recommended for catalyzing the metathesis of simple olefins (U.S. Pat. Nos. 3,641,189 and 3,676,520).

These catalysts can be prepared by the usual methods of heterogeneous catalysis on a porous substrate that consists of a refractory oxide that has an acidic, neutral or basic nature, such as aluminum oxide, silicon oxide, magnesium oxide or titanium oxide (U.S. Pat. No. 3,642,931). Among the various substrates, the alumina or a substrate that contains alumina can exhibit the most advantageous properties for imparting good activity and good stability to the catalyst.

Many modifications to the basic catalysts that comprise a compound of rhenium, molybdenum or tungsten on a porous substrate that consists of a refractory oxide have been described for improving their properties. Beneficial results were thus found with the addition of alkaline or alkaline-earth compounds (U.S. Pat. Nos. 3,594,440 and 3,637,892), acid anions (U.S. Pat. No. 3,697,613), tin oxides (Patent GB 1 377 161), boron oxide (U.S. Pat. No. 5,055,628), aluminum compounds (U.S. Pat. No. 5,898,092) or rare earth elements (U.S. Pat. No. 3,728,414).

The use of organometallic promoters, such as the alkyl complexes of tin or lead, combined with the basic catalyst, has also been described and allows the metathesis of functional olefins (see J. C. Mol, C. Boelhouwer et al., J. Chem. Soc. Chem. Comm., (1977), 198). These promoters can be advantageously used, moreover, for increasing the activity of the heterogeneous catalysts that are based on rhenium, molybdenum or tungsten in the metathesis of non-functional olefins. It is known, for example, that the addition of tin alkyl or lead alkyl to a catalyst that is based on rhenium and that rests on a mineral porous substrate and is calcined at a temperature of 200 to 1000° C. very significantly improves the activity of this catalyst and makes it possible to use, for an identical activity, smaller proportions of rhenium, which is important based on the cost of this metal. Without wanting to be tied by any theory, it seems that the presence of tin alkyl (or lead alkyl) promotes the formation of the active radical (carbene), but it concurrently increases the deactivation speed of the catalyst (R. Spronk, A. Andreini, J. C. Mol, J. Mol. Catal. 65, (1991), 219).

The regeneration of the catalyst then becomes a key factor. It is known that it is possible to regenerate the catalysts that are based on rhenium, molybdenum or tungsten on a porous substrate that consists of a refractory oxide and that comprises an organometallic promoter that consists of an alkyl complex of tin or lead, by high-temperature calcination. A new addition of promoter is then essential to recover the initial activity. This regeneration method exhibits the disadvantage that the tin oxide or lead oxide that is formed during the calcination accumulates on the surface of the catalyst close to the active sites and that the activity of the latter decreases with each operating cycle (R. Spronk, J. C. Mol, Appl. Catal. 76, (1991), 143).

This invention provides an improved process for regeneration of the metathesis catalysts that comprise at least one compound of rhenium, molybdenum or tungsten on a porous substrate that consists of a refractory oxide and that has an acidic, neutral or basic nature, and at least one organometallic promoter that is selected from among the alkyl complexes of tin and lead, whereby said process comprises at least one stage for extraction of the tin promoter or lead promoter, a stage for calcination of the catalyst that is thus treated and a stage for reimpregnation by the tin promoter or lead promoter.

It has actually been discovered, surprisingly enough, that it is possible, with a suitable extraction agent, to extract selectively at least 50% of the tin or lead that is introduced, whereby the basic metal (rhenium, molybdenum or tungsten) is not affected during this operation. The catalyst that has undergone extraction is optionally washed and dried, then calcined and supplemented with a new amount of promoter, which results in a catalyst of activity identical to that of the freshly prepared catalyst.

More particularly, the improved process for regenerating metathesis catalysts of the invention comprises the sequence of the following operations:

a) A stage in which at least 50% of the tin promoter or lead promoter is extracted by an extraction agent that is selected from the group that is formed by carboxylic acids RCOOH, sulfonic acids RSO₃H, carboxylic acid anhydrides (RCO)₂O, sulfonic acid anhydrides (RCO₂)₂O, alcohols and phenols ROH, thiols and thiophenols RSH, in which R is a hydrocarbyl radical that contains 1 to 40 carbon atoms, preferably 1 to 20 carbon atoms, for example alkyl, cycloalkyl, alkenyl, aryl, whereby this radical can be substituted by at least one halogen and at least one alkoxy group;

b) An optional stage in which the catalyst that is thus treated is washed with a hydrocarbon-containing solvent;

c) An optional stage in which it is dried to a temperature of 0 to 250° C.;

d) A stage in which it is activated thermally by a calcination at a temperature of 250 to 1000° C.; and

e) A stage in which it is impregnated by a new amount of tin promoter or lead promoter.

By way of examples of extraction agents and without the list being limiting, it is possible to cite acetic acid, propionic acid, ethyl-2-hexanoic acid, chloroacetic acid, trichloroacetic acid, trifluoroacetic acid, methane-sulfonic acid, trifluoromethane-sulfonic acid, acetic anhydride, trifluoromethane-sulfonic anhydride, methanol, propanol, n-butanol, ethyl-2-hexanol, phenol and thiophenol. Acetic acid is preferably used.

In the first stage of regeneration (a), the tin promoter or lead promoter is extracted by the extraction agent that is pure or diluted in a solvent. The extraction is carried out according to the known solid/liquid extraction techniques, but during the process, it is imperative to exclude air and moisture. The operation is preferably performed by displacement. The extraction agent is brought into contact with the deactivated catalyst and flows by, for example, simple gravity. In another embodiment, the extraction agent can be conveyed by a pump through the catalyst bed. It is possible to use a solvent for diluting the extraction agent. The amount of solvent is then adjusted so that the solution volume is considerably larger than the pore volume of the catalyst that is to be extracted. The solvent that is optionally used in this operation can be selected from among the solvents that are known to one skilled in the art. It preferably consists of an organic solvent, for example an aliphatic hydrocarbon such as pentane, hexane or heptane or an aromatic compound, such as benzene, toluene or a xylene, or else an ether such as diethyl ether, methyl tert-butyl ether or tetrahydrofuran. The extraction operation is carried out in general at a temperature of 0 to 200° C., preferably 20 to 100° C., and under a pressure of 0.1 to 5 MPa, preferably from 0.1 to 1 MPa.

Extraction stage (a) is optionally followed by a washing stage (b) that is intended to eliminate traces of the remaining extraction agent that is adsorbed at the surface of the catalyst. For this stage, a hydrocarbon-containing, aromatic or, preferably, aliphatic, solvent will advantageously be used. In this latter case, this can advantageously be the same solvent as the one that is used to dilute the extraction agent. The amount of solvent will be adjusted such that the volume is greater than the pore volume of the catalyst and the washing operation will be repeated several times until the extraction agent is eliminated.

After the stages for extraction and washing (optional), in a stage (c), in general drying is carried out under a vacuum or under a stream of preferably cover gas that is free of moisture, at a temperature of 0 to 250° C., preferably from 50 to 150° C.

The drying stage is followed by a thermal activation stage (d) that consists of a calcination at a temperature from 250 to 1000° C., and preferably 400 to 900° C., for a period of 10 minutes to 10 hours, and preferably from 30 minutes to 5 hours. After calcination, the solid is cooled under a dry and inert atmosphere, for example under nitrogen or under argon.

Last stage (e) consists of the impregnation of a new amount of tin promoter or lead promoter, according to the operating method that is described below.

The stages that are described above can be carried out successively in a single chamber, for example the metathesis reactor in the case of an implementation of the metathesis in batch mode or by operation in alternate reactors. In the case of an implementation of the metathesis reaction continuously, with simultaneous regeneration semi-continuously or continuously of the catalyst, the stages that are described above can be carried out in a chamber that is divided into zones and that are passed through successively by the moving-bed catalyst, whereby each zone is allotted to one of the stages of the regeneration process.

The catalyst that is based on rhenium, molybdenum or tungsten comprises at least three components: a porous mineral substrate, of 0.01 to 20% by weight of rhenium, molybdenum or tungsten in oxide form, and of 0.01 to 10% by weight of tin or lead, introduced in the form of an organometallic compound. The preparation of the catalyst preferably comprises, in order: the introduction on the substrate of a precursor of rhenium, molybdenum or tungsten; a calcination; then the introduction of the tin compound or lead compound.

The porous substrate is selected from the group that is formed by the acidic, neutral or basic refractory oxides. It is possible to cite as examples, without the list being limiting: aluminas, silica-aluminas, zeolites, titanium oxide, and magnesia. A mineral substrate with an acidic or neutral nature, more particularly an alumina or a silica-alumina that has a specific surface area of 10 to 400 m²/g, preferably at least 50 m²/g, and an adequate pore volume, for example from at least 0.1 ml/g, preferably 0.3 to 1 ml/g, is advantageously used. It is possible to use, for example, an alumina of the same type as those used for the catalytic reforming catalysts.

The precursor of the compound of rhenium, molybdenum or tungsten that is used is preferably selected from the group that is formed by rhenium heptoxide, ammonium perrhenate, perrhenic acid, ammonium molybdate, and ammonium tungstate. The compound of rhenium, molybdenum or tungsten can be introduced on the substrate by any method that is known to one skilled in the art, for example by vapor phase sublimation, by impregnation in solution or by impregnation in the dry state. In this latter method, which is preferred, the compound of rhenium, molybdenum or tungsten is put into solution in water or in an organic solvent, for example a hydrocarbon, an alcohol or an ether. The amount of metal on the substrate is regulated by the selection of the concentration of the impregnation solution, whereby its amount is such that the volume of this solution is equal to or slightly less than the pore volume of the solid to be impregnated. When the amount of metal that it is desired to impregnate is greater than that which makes it possible to introduce a solution at its saturation limit, the operation should be carried out several times, with intermediate drying to eliminate the impregnation solvent, at a temperature of, for example, 90 to 250° C., preferably from 100 to 180° C. This makes it possible to introduce 0.01 to 20%, preferably 0.1 to 15%, and even more advantageously 0.5 to 10% by weight of metal.

After the introduction of the precursor of rhenium, molybdenum or tungsten on the substrate, drying is carried out at a temperature of, for example, 90 to 250° C., preferably 100 to 180° C., then a calcination at a temperature of, for example, 250 to 1000° C., preferably 400 to 900° C., for a period of 10 minutes to 10 hours, preferably 30 minutes to 5 hours. After calcination, the solid is cooled under a dry and inert atmosphere, for example under nitrogen or under argon.

The regeneration process according to the invention is particularly advantageous in the case of catalysts that are based on rhenium. Any existing substrate that is loaded with rhenium oxide is suitable, and any preparation method is acceptable. Also, the rhenium-based catalysts that are currently marketed can be suitable.

The promoter organometallic compound that contains tin or lead corresponds to general formula R′₄M, in which R′ is an aliphatic hydrocarbyl radical that contains 1 to 40 carbon atoms, for example alkyl or cycloalkyl, which may or may not be substituted. By way of example and without the list being limiting, R′ can be a methyl, ethyl, n-propyl, isopropyl, n-butyl, t-butyl, cyclohexyl, or benzyl radical, whereby M is selected from the group that is formed by tin and lead.

The promoter organometallic compound can be introduced on the substrate by any of the methods that are known to one that is skilled in the art, but during the process, it is imperative to exclude air and moisture. It is possible to impregnate the substrate by excess solution that contains the compound R′₄M. After a contact time that can go from several minutes to several days, the solid is drained, and it is optionally washed with a solvent to eliminate the portion of the compound that has not set. It is also possible, in an operating mode that is preferred, to use the dry impregnation method. The concentration of tin or lead of the solution is then adjusted based on the amount that it is desired to deposit on the solid so that the volume of this solution is equal to or slightly less than the pore volume of the solid that is to be impregnated. The solvent that is used in this impregnation is preferably an organic solvent, for example an aliphatic or aromatic hydrocarbon, such as pentane, hexane, heptane, benzene, toluene or a xylene. This makes it possible to introduce from 0.01 to 10%, preferably from 0.05 to 5% and still more advantageously from 0.1 to 5% by weight of metal.

After the promoter compound is introduced, the preparation of the catalyst can be terminated by drying, under vacuum or under a stream of preferably cover gas, at a temperature of 0 to 1000° C., preferably at a temperature that is close to ambient temperature, 0 to 50° C. No activation operation, chemical or thermal, is necessary to trigger the activity of these catalysts, and calcination is not recommended. It is sufficient to put them in contact with an olefin so that the metathesis reaction starts up.

The addition of compound R′₄M to the catalyst can thus advantageously take place in situ in the metathesis reactor, before the reaction, or else ex situ, and the modified catalyst is directly loaded into the reactor for the reaction. In the first case (in situ), the compound can also be introduced with the feedstock that is to be treated.

The olefins that can react in metathesis in the presence of the supported rhenium-based catalyst that is described above can be linear olefins that correspond to the general formula: R¹R²C═CR³R⁴, where R¹, R², R³ and R⁴, identical or different, are hydrogen or a hydrocarbyl radical of 1 to 20 carbon atoms. The olefins can also have a cyclic structure, whereby the cycle comprises 3 to 20 carbon atoms. It is possible either to react an olefin on itself or to react several olefins mixed with one another (co-metathesis). An application example is the production of propylene by reaction of ethylene with butenes-2, or the inverse reaction of transforming propylene into a mixture of ethylene and butenes-2.

Other olefins that can react in metathesis are the mono-olefins or the polyolefins that are linear or cyclic and that carry functional groups, such as, for example, halogen atoms or ester groups. In this connection, it is possible to cite alkyl esters of unsaturated fatty acids, such as the oleates, the linoleates and the alkyl linoleates. The metathesis of an alkyl oleate on itself thus yields an internal olefin of C₁₈ and an unsaturated C₁₈-diester of alkyl. The co-metathesis of an alkyl oleate with the ethylene yields decene-1 and the corresponding alkyl decenoate.

The metathesis reaction is carried out preferably in the absence of solvent. The presence of a solvent such as a hydrocarbon, or a halogenated, aliphatic, cyclanic or aromatic hydrocarbon, is not harmful, however. The metathesis reaction is carried out in a gaseous phase or in a liquid phase. The reaction can be carried out in batch mode in a stirred reactor or continuously, by passage of the reagent or reagents through a fixed bed, a moving bed or a fluidized catalyst bed.

The pressure at which the reaction is carried out is not critical. For a liquid-phase operation, however, it is necessary to maintain a pressure that is at least equal to the vapor pressure of the reaction mixture at the temperature of the reaction. The operation is carried out at a temperature of between 0 and 500° C., preferably between 20 and 150° C. in the case of rhenium-based catalysts.

The following examples illustrate the invention without limiting the scope thereof.

### EXAMPLE 1

Preparation of the Catalyst:

8.55 g of a cubic gamma alumina that has a specific surface area of 184 m²/g and a pore volume of 0.67 ml/g is calcined at 300° C. in air. A solution is prepared for dry impregnation of the rhenium by diluting 0.21 ml of a concentrated aqueous solution of perrhenic acid that contains 54.08% by weight of rhenium (specific mass: 2.417 g/ml) in 5 ml of water. This solution is impregnated on the solid that is calcined above. After 30 minutes of contact at ambient temperature, the solid that is obtained is dried in an oven at 120° C. for one night. It is then calcined in a stream of air (about 20l/h) that is dried by passage through a molecular sieve bed at a temperature of 650° C. for 2 hours. During the subsequent cooling period, a stream of dry nitrogen is substituted for the stream of air. 10 g of activated catalyst that is kept in a dry and inert atmosphere before use is thus obtained.

A solution that contains 25 μl of tetraethyl tin SnEt₄ in 4 ml of pentane is impregnated on 8 g of this solid. A metathesis catalyst that contains 2.8% by weight of rhenium and 0.14% by weight of tin and that is kept in a dry and inert atmosphere before use is thus obtained.

Use in Metathesis (1^{st} Test):

The catalyst that is prepared above is loaded in the absence of air and moisture into a reactor that consists of a stainless steel tube that is equipped with a double water-circulating jacket that allows for temperature regulation. Liquid propylene is injected by means of a pump via the bottom of the reactor with a flow rate of 46 g/h. The temperature is regulated to 35° C., and the pressure is kept at 3.5 MPa by means of a regulator that is placed downstream from the reactor. Under these conditions, the initial conversion of the propylene at the outlet of the reactor is 40%, in an equimolar mixture of ethylene and butenes-2. The catalyst is partially deactivated after 30 hours of testing, since the conversion of the propylene at 30 hours is 25%.

Regeneration:

At the end of the first test above, the deactivated catalyst is transferred outside of the reactor, protected from air and moisture, extracted by 3× a solution of 5 ml of acetic acid in 25 ml of pentane and then washed by 5×20 ml of pentane, always under inert atmosphere. The dosage of the tin in all of the extraction and washing solutions shows that 100% of the tin that is initially introduced was extracted.

The catalyst is then dried under dynamic vacuum, calcined at 120° C. for 1 hour and then at 650° C. for 3 hours under a stream of dry air. After cooling under a stream of dry nitrogen, a solution that contains 25 μl of SnEt₄ in 4 ml of pentane is impregnated on this catalyst. A regenerated metathesis catalyst that is kept in a dry and inert atmosphere before use is thus obtained.

Use in Metathesis (2^{nd} Test):

The catalyst that is regenerated above is used for the metathesis reaction in the same reactor and under the same conditions as described for the first test. The initial conversion of the propylene at the outlet of the reactor is 40%, in an equimolar mixture of ethylene and butenes-2.

After 30 hours, this second test is halted, and the catalyst is transferred outside of the reactor and then calcined at 650° C. for 3 hours in a stream of dry air. Its metallic rhenium content is 2.7% by weight and its metallic tin content is 0.14% by weight, which corresponds to the amount of tin that is introduced during the regeneration.

### EXAMPLE 2

This example is identical to the preceding one, with the difference that during the regeneration stage, the acetic acid that is used for the extraction is diluted in the diethyl ether and that the washing after extraction is carried out with diethyl ether. The conversion of the propylene at the beginning of the first test is 38%. It is 24.3% after 30 hours of operation. The extraction solution that is recovered during the regeneration contains more than 95% of the tin that is initially introduced.

After regeneration, the conversion of the propylene at the beginning of the second test is 38%. After 30 hours, this second test is halted, and the catalyst is transferred outside of the reactor, then calcined at 650° C. for 3 hours in a stream of dry air. Its metallic rhenium content is 2.7% by weight, and its metallic tin content is 0.13% by weight, which corresponds to the amount of tin that is introduced during the regeneration.

### EXAMPLE 3 (FOR COMPARISON)

Preparation of the Catalyst:

A new lot of 8 g of catalyst is prepared as in Example 1 by the stages for impregnation of rhenium, drying, calcination and impregnation of SnEt₄.

Use in Metathesis:

The catalyst that is prepared above is loaded into the same apparatus as the one that is described in Example 1. Liquid propylene is injected by means of a pump via the bottom of the reactor, with a flow rate of 46 g/h. The temperature is regulated to 35° C., and the pressure is kept at 3.5 MPa with a regulator that is placed downstream from the reactor. Under these conditions, the initial conversion of the propylene at the outlet of the reactor is 40% in an equimolar mixture of ethylene and butenes-2.

After 30 hours of testing, this catalyst is recovered in the absence of air and moisture, then calcined at 650° C. for 3 hours in a stream of dry air. Its metallic rhenium content is 2.72% by weight, and its metallic tin content is 0.12% by weight.

This example shows that simple calcination causes virtually no removal of tin. The tin will therefore accumulate later on the catalyst as regenerations proceed.

### EXAMPLE 4 (FOR COMPARISON)

Preparation of the Catalyst:

A new lot of catalyst is prepared as in Example 1, except for this difference that the impregnation stage by SnEt₄ is omitted. The impregnation stage of the rhenium as well as the phase of drying and calcination are identical to those described in Example 1. A catalyst that contains 2.8% by weight of metallic rhenium is obtained. It is kept in a dry and inert atmosphere before use.

Use in Metathesis:

10 g of the catalyst that is prepared above is loaded into the same apparatus as the one that is described in Example 1. Liquid propylene is injected by means of a pump via the bottom of the reactor, with a flow rate of 46 g/h. The temperature is regulated to 35° C., and the pressure is kept at 3.5 MPa by means of a regulator that is placed downstream from the reactor. Under these conditions, the initial conversion of the propylene at the outlet of the reactor is 7.4% in an equimolar mixture of ethylene and butenes-2.

This comparison example illustrates the progress provided by the presence of the organometallic promoter regarding the activity of the catalyst.

### EXAMPLE 5

A sample (5 g) of catalyst that is prepared according to the process steps described in Example 1, containing 2.8% by weight of rhenium and 0.14% by weight of tin, is brought into static contact with 20 ml of a pentene-2 solution in pentane (1/1 by volume) for one week. The catalyst is then separated by decanting under a dry and inert atmosphere, then extracted by 3× a solution of 5 ml of acetic acid in 25 ml of diethyl ether and washed by 5×20 ml of diethyl ether. It is then dried under dynamic vacuum and calcined at 120° C. for 1 hour and then at 650° C. for 3 hours in a stream of dry air.

The analysis of the solid that is obtained shows that less than 0.01% by weight of tin remains on the catalyst and that its rhenium content is identical to the initial content. More than 92% of the tin that is introduced was therefore extracted.

### EXAMPLE 6

This example is identical to the preceding one with the difference that the extraction agent that is used is trifluoroacetic acid that is diluted in pentane, whereby the consecutive washing is also carried out with pentane. After extraction, 0.03% by weight of metallic tin remains on the catalyst, and its rhenium content is identical to the initial content. More than 78% of the tin that is introduced was extracted.

### EXAMPLE 7

This example is identical to Example 5 with the difference that the extraction agent that is used is propanol-1. After extraction, 0.06% by weight of tin remains on the catalyst, and its rhenium content is identical to the initial content. More than 57% of the tin that is introduced was extracted.

### EXAMPLE 8

This example is identical to Example 5 with the difference that the extraction agent that is used is trifluoroacetic anhydride. After extraction, 0.07% by weight of metallic tin remains on the catalyst, and its rhenium content is identical to the initial content. More than 50% of the tin that is introduced was extracted.

1. Process for regeneration of metathesis catalysts that comprise at least one compound of rhenium, molybdenum or tungsten, on a porous substrate that consists of a refractory oxide and at least one organometallic promoter that is selected from among the alkyl complexes of tin and lead that correspond to general formula R′₄M, in which R′ is an aliphatic hydrocarbyl radical that contains 1 to 40 carbon atoms, whereby M is selected from the group that is formed by tin and lead, and whereby said process is characterized in that it comprises at least one stage for extraction of the promoter that contains tin or lead, a stage for calcination of the thus treated catalyst and a stage for reimpregnation of the catalyst by the promoter that contains tin or lead.

2. Process according to claim 1, wherein it successively comprises:
a) A stage in which, in the absence of air and moisture, at least 50% of the tin promoter or lead promoter is extracted by an extraction agent that is selected from the group that is formed by carboxylic acids RCOOH, sulfonic acids RSO₃H, carboxylic acid anhydrides (RCO)₂O, sulfonic acid anhydrides (RSO₂)₂O, alcohols and phenols ROH, thiols and thiophenols RSH, in which R is a hydrocarbyl radical that contains 1 to 40 carbon atoms, preferably 1 to 20 carbon atoms, for example alkyl, cycloalkyl, alkenyl, aryl, whereby this radical can be substituted by at least one halogen or at least one alkoxy group;
b) A stage in which the catalyst that is thus treated is washed with a hydrocarbon-containing solvent;
c) A stage in which it is dried to a temperature of 0 to 250° C.;
d) A stage in which it is activated thermally by calcination at a temperature of 250 to 1000° C.; and
e) A stage in which it is impregnated by a new amount of tin promoter or lead promoter.

3. Process according to claim 2, wherein in stage (a), the extraction agent is selected from among acetic acid, propionic acid, ethyl-2-hexanoic acid, chloroacetic acid, trichloroacetic acid, trifluoroacetic acid, methane-sulfonic acid, trifluoromethane-sulfonic acid, acetic anhydride, trifluoromethane-sulfonic anhydride, methanol, propanol, n-butanol, ethyl-2 hexanol, phenol and thiophenol.

4. Process according to claim 3, wherein in stage (a), the extraction agent is acetic acid.

5. Process according to one of claims 2 to 4, wherein in stage (a), the extraction operation is carried out at a temperature of 0 to 200° C. and under a pressure of 0.1 to 5 MPa.

6. Process according to one of claims 2 to 5, wherein in stage (a), the extraction agent is diluted by an organic solvent that is selected from among the aliphatic or aromatic hydrocarbons and the ethers.

7. Process according to one of claims 2 to 5, wherein in stage (b), the catalyst is washed after extraction with an aromatic or aliphatic hydrocarbon-containing solvent.

8. Process according to claim 6, wherein in stage (b), the catalyst is washed after extraction with the same solvent as the one that is used to dilute the extraction agent.

9. Process according to one of claims 2 to 8, wherein in stage (d), calcination is carried out at a temperature of 250 to 1000° C., for a period of 10 minutes to 10 hours, then the solid is cooled under a dry and inert atmosphere.

10. Process according to one of claims 2 to 9, wherein in stage (e), the promoter organometallic compound that contains tin or lead corresponds to general formula R′₄M, in which R′ is an aliphatic radical that contains 1 to 40 carbon atoms, whereby M is selected from the group that is formed by tin and lead and is introduced on the substrate in the absence of air and moisture.

11. Process according to one of claims 2 to 10, wherein in stage (e), the substrate is impregnated by excess solution that contains compound R′₄M, then after a contact time of several minutes to several days, the solid is drained, and it is washed with a solvent to eliminate the portion of the compound that is not set so as to introduce the desired amount of promoter.

12. Process according to one of claims 1 to 11, wherein the metathesis catalyst that is based on rhenium, molybdenum or tungsten comprises at least three components: a mineral porous substrate, and, in % by weight relative to the substrate, 0.01 to 20% of rhenium, molybdenum or tungsten in oxide form and 0.01 to 10% tin or lead, introduced in the form of an organometallic compound.

13. Process according to claim 12, wherein the metathesis catalyst comprises rhenium in oxide form on a substrate that consists of at least alumina and a tin alkyl complex promoter.

14. Process for metathesis that uses a catalyst that comprises at least one compound of rhenium, molybdenum or tungsten, on a porous substrate that consists of a refractory oxide and at least one organometallic promoter that is selected from among the alkyl complexes of tin and lead, wherein it includes a process for regenerating the catalyst according to one of claims 1 to 13.
